(19) United States
(12) Patent Application Publication
(10) Pub. No.: US 2007/0174544 A1
(43) Pub. Date: Jul. 26, 2007

(54) Data processing system and data processing method

(75) Inventors: Miyuki Yasuda, Odawara (JP); Hidetoshi Sakaki, Odawara (JP); Isamu Kurokawa, Odawara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/376,096

(22) Filed: Mar. 16, 2006

(30) Foreign Application Priority Data
Jan. 26, 2006 (JP) 2006-17144

(51) Int. Cl. G06F 12/00

(52) U.S. Cl. 711/112

(57) ABSTRACT

A data processing system including a disc unit having a plurality of logical devices, a central processing unit for issuing commands with the plurality of logical devices designated as a processing range, and a disc controller for executing the commands for all of the logical devices designated as the processing range. The commands are issued by the central processing unit to the disc controller by executing an initial program load or channel path online.

### CROSS-REFERENCES TO RELATED APPLICATIONS

This application relates to and claims priority from Japanese Patent Application No. 2006-17144, filed on Jan. 26, 2006, the entire disclosure of which is incorporated herein by reference.

### BACKGROUND OF THE INVENTION

1. Field of the Invention

The present invention relates to a data processing system and data processing method.

2. Description of the Related Art

In mainframe data processing systems, in the event that there is a request to transfer data from a central processing unit to a disc controller, a CCW (Channel Command Word) chain where WRITE commands are chained at a DX(Define Extent)/LOC(LOCate record) are issued at a disc controller, while in the event that data transfer is requested from a disc controller to a central processing unit, a CCW chain where READ commands are chained at DX/LOC is issued at the disc controller.

Technology for reducing overhead due to CCW chain communication between a central processing unit and a disc controller is disclosed in Japanese Patent Laid-open Publication No. 2002-287908. Here, a CCW chain is bound at the central processing unit and a plurality of CCW's are collectively sent to the disc controller. The CCW chains are then separated and processed at the disc controller. As a result, overhead due to CCW chain communication between the central processing unit and the disc controller is reduced. In addition, Japanese Patent Laid-open Publication No. 2000-163354, and Japanese Patent Laid-open Publication No. Hei. 10-333836 are well-known as documents referring to CCW chain processing.

### SUMMARY OF THE INVENTION

It is, however, necessary to issue control (CTL) and sense (SNS) commands for all of the logical devices defined in the host generation in order to execute processes such as initial program load (IPL) and channel path online (CHP ON). In recent years, there has been a tendency for the number of logical devices mounted on a disc unit to increase. This means that during processes such as initial program load and channel path online, the same commands are issued for a large number of logical devices which means that the time required to complete a process becomes long.

In order to resolve this kind of problem, it is advantageous for the present invention to shorten processing time for initial program load and channel path online etc.

In order to resolve the aforementioned problem, a data processing system of the present invention is comprised of a disc unit having a plurality of logical devices, a central processing unit issuing a CTL command for routing/device checking, a CTL command for mode setting/reading, an SNS command for mode setting/reading, or a CTL/SNS command for mode setting/reading taking a plurality of logical devices as a processing range, and a disc controller for executing the commands for all of the logical devices designated as the processing range. The commands are issued from the central processing unit to the disc controller upon execution of initial program load or channel path online.

According to the present invention, it is possible to shorten processing time for processes such as initial program load and channel path online.

### DESCRIPTION OF THE DRAWINGS

FIG. 1 is a system configuration view of a data processing system of an embodiment.

FIG. 2 is a view of IPL processes and CHP ON processes.

FIG. 3 is a system configuration view of a central processing unit.

FIG. 4 is a view illustrating control information for enabling a channel section to issue commands.

FIG. 5 is a sequence view of write and control commands of the related art.

FIG. 6 is a sequence view of consolidated commands for a writing and control of this embodiment.

FIG. 7 is a view illustrating consolidated commands for a writing and control and sensing commands chained for these consolidated commands.

FIG. 8 is a sequence view of read commands and sensing commands of the related art.

FIG. 9 is a sequence view of consolidated commands for a reading and sensing of this embodiment.

FIG. 10 is a view illustrating consolidated commands for a reading and sensing and sensing commands chained for these consolidated commands.

FIG. 11 is a view illustrating a frame structure for consolidated commands of this embodiment.

FIG. 12A-12E are views illustrating a method of designating device mapping.

FIG. 13 is a flowchart showing a consolidated command generation process.

FIG. 14 is a flowchart showing I/O issuance processing.

FIG. 15 is a view illustrating an outline of a disc controller processing consolidated commands.

FIG. 16 is a flowchart showing command receipt processing occurring at a disc controller.

FIG. 17 is a flowchart showing a process A.

FIG. 18 is a flowchart showing a process B.

FIG. 19 is a flowchart showing a process C.

FIG. 20 is a flowchart showing a process D.

FIG. 21 is a view illustrating a data format for response data.

FIG. 22 is a view illustrating an outline of a central processing unit processing response data.

FIG. 23 is a flowchart describing response data receipt processing occurring at a central processing unit.

FIG. 24 is a flowchart showing a process E.

FIG. 25 is a flowchart showing a process F.

FIG. 26 is a flowchart showing a process G.

FIG. 27 is a flowchart showing a process H.

FIG. 28 is a view showing an outline of a configuration for a data processing system.

FIG. 29 is a view showing a sequence for issuing an alias consolidation command.

FIG. 30 is a view showing an outline of a configuration for a data processing system.

FIG. 31 is a flowchart showing a process executed by a disc controller receiving a SET PI consolidated command.

FIG. 32 is a view showing an outline of a configuration for an open data processing system.

FIG. 33 is a sequence view showing a consolidated command issuance procedure occurring in an open system.

FIG. 34 is a further sequence view showing a consolidated command issuance procedure occurring in an open system.

### DETAILED DESCRIPTION OF THE EMBODIMENT

The following is a description with reference to each of the drawings of an embodiment of the present invention.

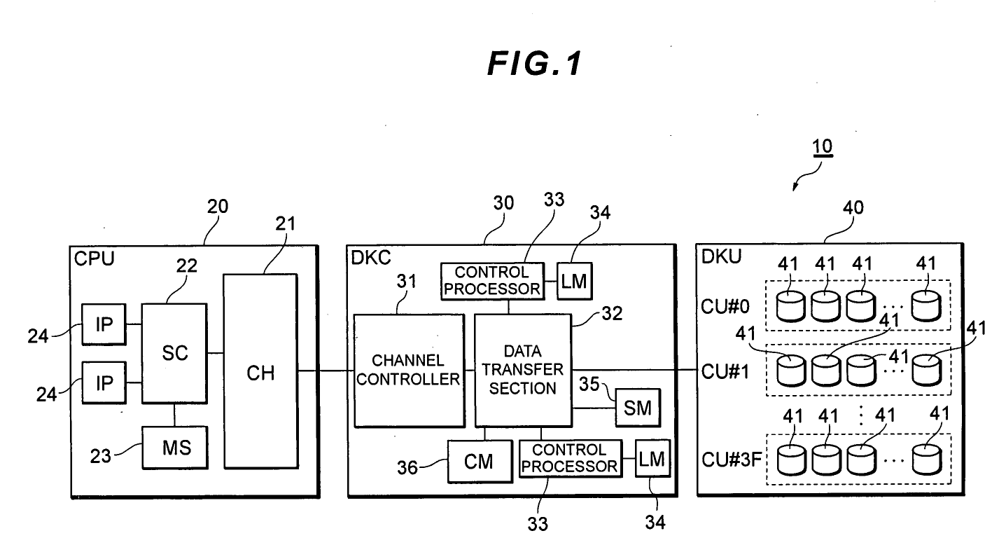

FIG. 1 shows a system configuration view of a data processing system 10 of the embodiment. The data processing system 10 is comprised of a central processing unit (CPU) 20, disc controller (DKC) 30, and disc unit (DKU) 40.

The central processing unit 20 is for a mainframe computer system comprised of a channel section (CH) 21, system controller (SC) 22, main storage (MS) 23 and arithmetic processing unit (IP) 24. The channel section 21 controls an interface connected to a channel controller 31 within the disc controller 30. The system controller 22 controls data transfer via the channel section 21. The main storage 23 stores various programs and data processed by programs, etc. The arithmetic processing unit 24 executes an operating system and user programs etc.

The disc controller 30 is comprised of the channel controller 31, a data transfer section 32, a control processor 33, local memory (LM) 34, shared memory (SM) 35, and cache memory (CM) 36. The channel controller 31 controls an interface connected to the channel section 21 within the central processing unit 20. The data transfer section 32 controls transfer of data between the channel controller 31, the control processor 33, the cache memory 36 and the disc unit 40. The control processor 33 executes processing etc. for commands issued by the central processing unit 20. The local memory 34 functions as a work area etc. for control processor 33. The shared memory 35 stores configuration information etc. for the disc unit 40. The cache memory 36 temporarily stores data transferred between the central processing unit 20 and the disc unit 40.

The disc unit 40 is equipped with a plurality of logical devices 41. Each logical device 41 is grouped into units by control unit number (CU#). The logical device 41 is configured, for example, four storage devices grouped together into one set (3D+1P), or eight storage devices grouped together into one set (7D+1P). The storage device is a hard disc drive, flexible disc drive, magnetic tape drive, semiconductor memory drive, or optical disc drive, etc.

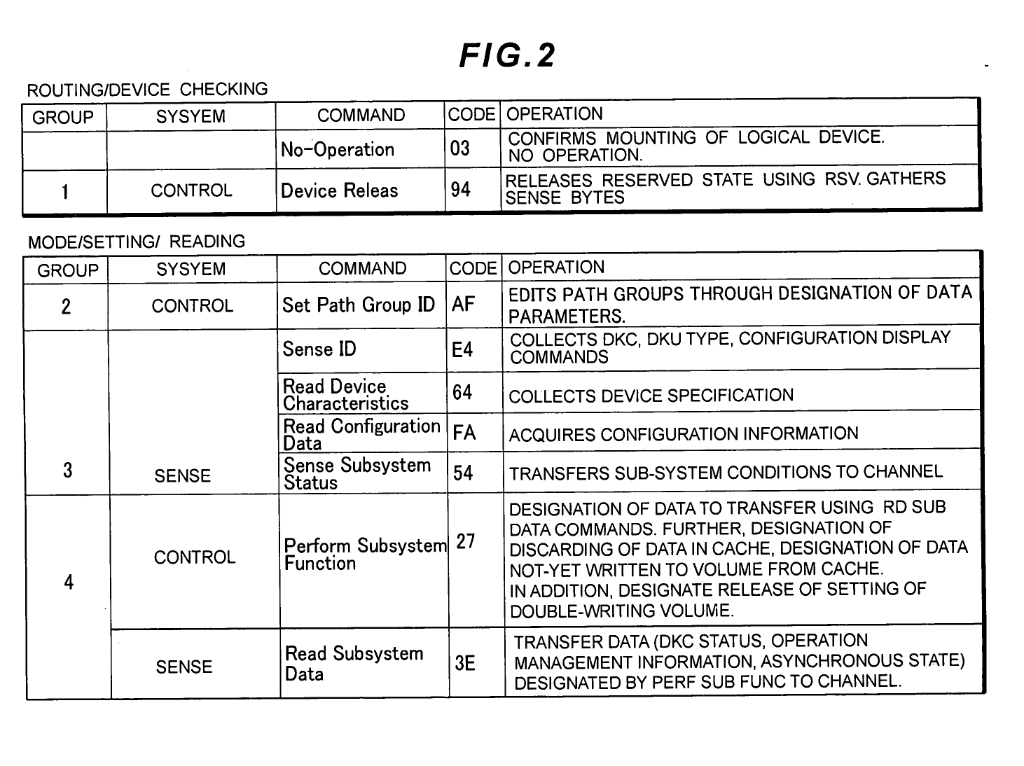

FIG. 2 shows commands issued by the central processing unit 20 when an IPL process or CHPON process is executed.

The IPL process is a process that is carried out when an operating system within the central processing unit 20 is re-started. Configuration information (configuration information for logical devices and logical paths etc.) managed within the central processing unit 20 and the disc controller 30 is reset once. The CHP ON process is a process that is carried out when a logical path connected across the central processing unit 20 and logical device 41 is put online, and defines logic paths connected to respective logical devices 41. When the IPL process or CHP ON process is executed, control or sense commands are issued by the central processing unit 20 to all of the respective logical devices 41 defined by host generation. For example, in establishing a logical path using a CHP ON process, an ELP (Establish Logical Path) is issued in control unit units, and a logical path number is acquired using control unit units so that a logical path is established in control unit units. Next, a logical path is set up by issuing a SET PI command from all of the logical paths to all of the logical devices 41. In the related art, it has been necessary for the SET PI command to only issue a number that is the number of logical paths multiplied by the number of logical devices.

In the same drawing, when an IPL process or CHP ON process is executed, commands issued by the central processing unit 20 are roughly classified into routing/device checking commands, and mode setting/reading commands.

An NOP (NO-Operation) is a command for confirming mounting of a logical device 41, and does not execute any operation.

RLS (Device Release) is a command for releasing a reserve state using RSV (Device Reserve). Further, RLS collects sense bytes.

SET PI (Set Path Group ID) is a command for editing path groups of a logical path.

SNS ID (Sense ID) is a command for collecting configuration commands.

RD CHR (Read Device Characteristics) is a command for collecting device specifications.

READ CONF (Read Configuration Data) is a command for acquiring configuration information.

SNS SUB STS (Sense Subsystem Status) is a command for transferring states of the disc controller 30 and the disc unit 40 to the channel section 21.

PERFR SUB FUNC (Perform Subsystem Function) is a command for designating data to be transferred using the RD SUB DATA command.

RD SUB DATA (Read Subsystem Data) is a command for transferring data designated by the PERF SUB FUNC command to the channel section 21.

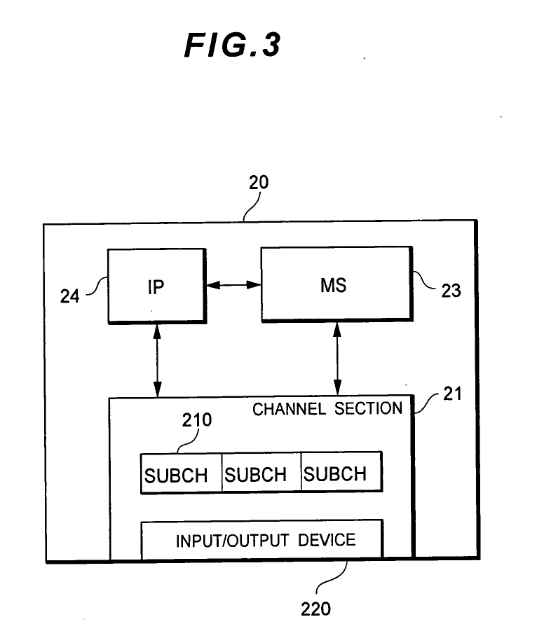

FIG. 3 shows a system configuration for the central processing unit 20. Devices with the same numerals as numerals shown in FIG. 1 are the same devices and detailed description thereof is therefore omitted. The channel section 21 is comprised of a plurality of sub-channels (SUBCH) 210 and an input/output device 220. Sub-channels 210 control data transfer between the main storage 23 and the disc controller 30. The input/output device 220 transmits and receives command frames and data frames.

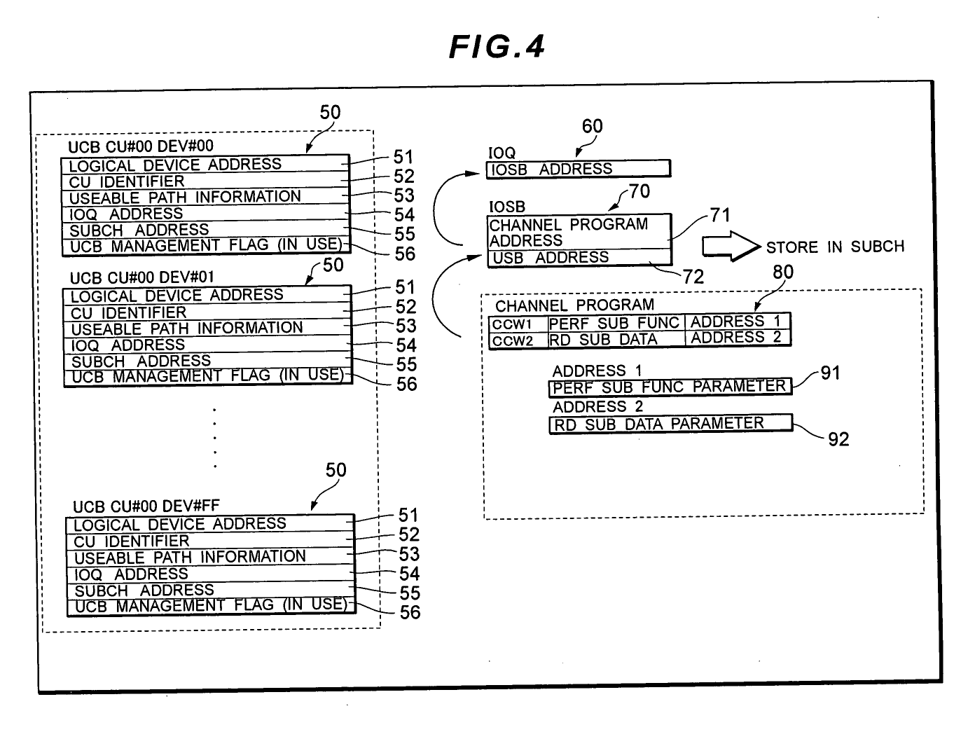

FIG. 4 shows control information used by the channel section 21 to issue commands. These items of control information are stored in the main storage 23. The control information includes a plurality of UCB's (Unit Control Blocks) 50, an IOQ (Input Output Queue) 60, an IOSB (Input Output Service Block) 70, and a channel program 80.

The UCB 50 is a set of various types of data including information necessary in access requests to the logical devices 41, with one UCB 50 corresponding to one logical device 41. The UCB 50 is comprised of an address 51 of the logical device 41, a CU identifier 52 for identifying the control unit, useable path information 53, an IOQ address 54, a sub-channel address 55, and a UCB management flag 56. A management flag 56 is flag information indicating whether or not the logical device 41 has resources available, i.e., whether or not any kind of command is the target of processing. Only one command can be issued for one logical device 41.

IOQ (Input Output Queue) 60 is an input/output queue for managing input/output requests.

IOSB is an input/output service block correlating to the IOQ 60.

Channel program 80 is comprised of a CCW chain. Parameters 91, 92 designated by address fields of the CCW chain are included in the channel program 80.

A processing procedure for issuing commands using the above control information is described in the following.

The central processing unit 20 consolidates the same commands respectively issued by the plurality of logical devices into a single command (hereinafter referred to as a “consolidated command”) and sends the single consolidated command to the disc controller 30. The disc controller 30 executes command processing for all of the logical devices 41 designated in the consolidated command. Units of, for example, control units etc. can be given as units for consolidating the plurality of commands.

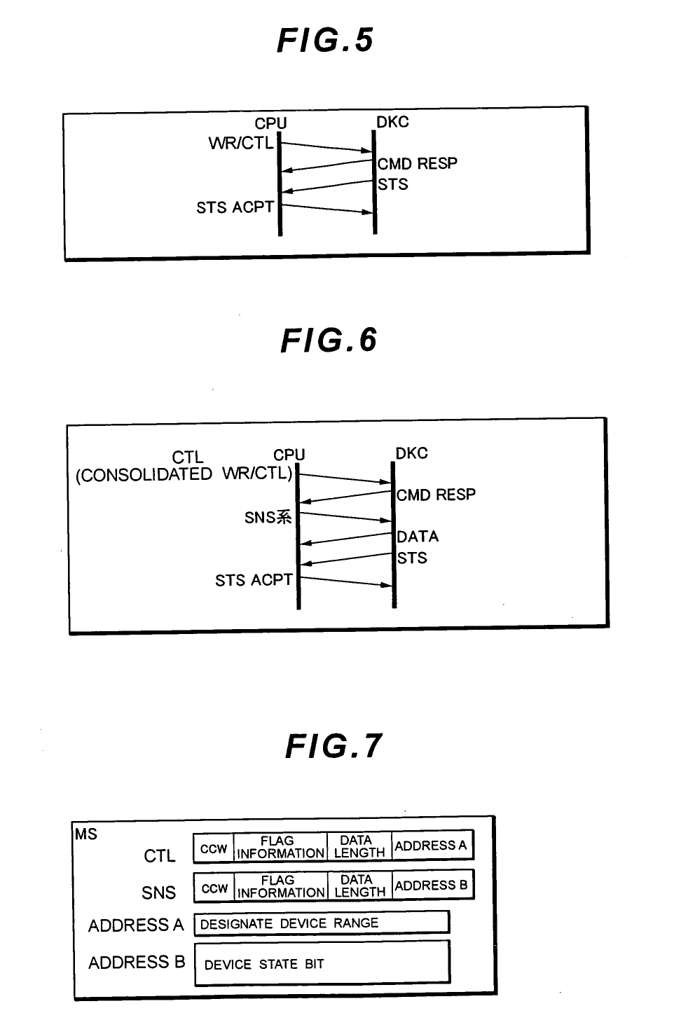

FIG. 5 shows a sequence for write and control commands of the related art. When the central processing unit 20 issues write or control commands to the disc controller 30, the disc controller 30 returns a command response and returns a status (STS). The central processing unit 20 receiving the status (STS) then returns a status acceptance signal (STS ACPT).

The channel program 80 includes flag information indicating command codes and command chain information etc., a transfer count indicating the amount of data for the command to transfer, and address fields indicating the positions of data or parameters. With commands of the related art for writing and control, it is possible to store data written to logical device 41 or cache memory 36 in address 2 but it is not possible to return information acquired through processing requests to a plurality of logical devices 41 from the disc controller 30 to the central processing unit 20. This is because the processing procedure for returning information acquired through processing requests to the plurality of logical devices 41 to the central processing unit 20 cannot be stipulated in the commands of the related art for writing and control.

FIG. 6 is a view showing a sequence of consolidated commands for writing and controlling of this embodiment. The point of distinction with the sequence of FIG. 5 described above is that a sense command (SNS) is chained at the consolidated command ((consolidated WR/CTL) control command) for writing and control, the sense command (SNS) is issued to the disc controller 30 by the central processing unit 20, and information required as a result of processing requests to the plurality of logical devices 41 is returned from the disc controller 30 to the central processing unit 20 as device data (DATA) as a sense command (SNS) response. The central processing unit 20 is capable of receiving information acquired by making processing requests to the plurality of logical devices 41 by chaining sense commands (SNS) at the consolidated command ((control command for (consolidated WR/CTL)) for writing and control.

FIG. 7 shows consolidated commands for a writing and control stored in the main storage 23, and sense commands chained to these consolidated commands. Address A stored in an address field of the consolidated command indicates the storage position of information indicating the designated range of the logical devices 41. Address B stored in an address field of the sense command indicates the position of storage of information (for example, read information) acquired by processing requests to the logical devices 41.

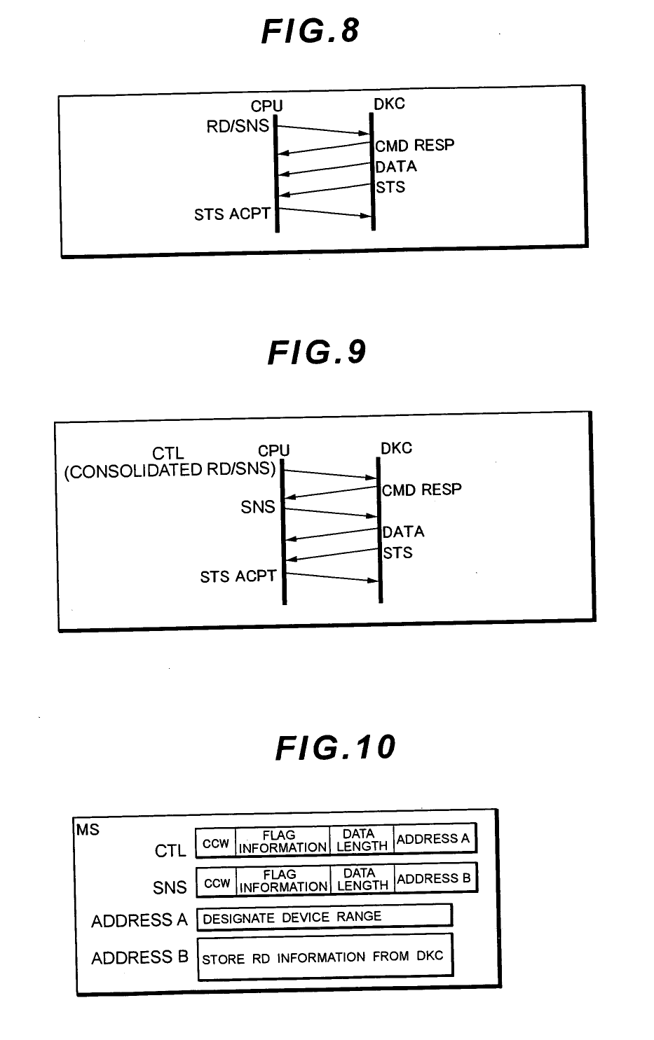

FIG. 8 shows a sequence of reading and sensing commands of the related art. When the central processing unit 20 issues read or sense commands to the disc controller 30, the disc controller 30 returns a command response and returns data (DATA) and status (STS). The central processing unit 20 receiving the status (STS) then returns a status acceptance signal (STS ACPT).

Commands of the related art for reading and sensing are capable of storing data read from the disc controller 30 in address 1 but device range cannot be stipulated. This is because it is only possible to issue one read or sense command for one logical device 41.

FIG. 9 shows a sequence of consolidated commands for reading and sensing of this embodiment. The point of distinction with the sequence of FIG. 5 described above is that a sense command (SNS) is chained at the consolidated command ((consolidated RD/SNS) control command) for reading and sensing, the sense command (SNS) is issued to the disc controller 30 by the central processing unit 20, and information required as a result of processing requests to the plurality of logical devices 41 is returned from the disc controller 30 to the central processing unit 20 as device data (DATA) as a response for the sense command (SNS). The central processing unit 20 is capable of receiving information acquired by making processing requests to the plurality of logical devices 41 by chaining sense commands (SNS) at the consolidated command ((control command for (consolidated RD/SNS)) for reading and sensing.

FIG. 10 shows consolidated commands for reading and sensing stored in the main storage 23, and sensing commands chained for these consolidated commands. Address A stored in an address field of the consolidated command indicates the storage position of information indicating the designated range of the logical devices 41. Address B stored in an address field of the sense command indicates the position of storage of information (for example, read information) acquired by processing requests to the logical devices 41.

In the related art, it is not necessary to chain sense commands at the consolidated command as shown in FIG. 6 and FIG. 9 because the RD SUB DATA commands for data reading are chained at the PERF SUB FUNC command. However, in the event that the PERF SUB FUNC commands are converted to a consolidated command, it is necessary to stipulate device range in the consolidated command.

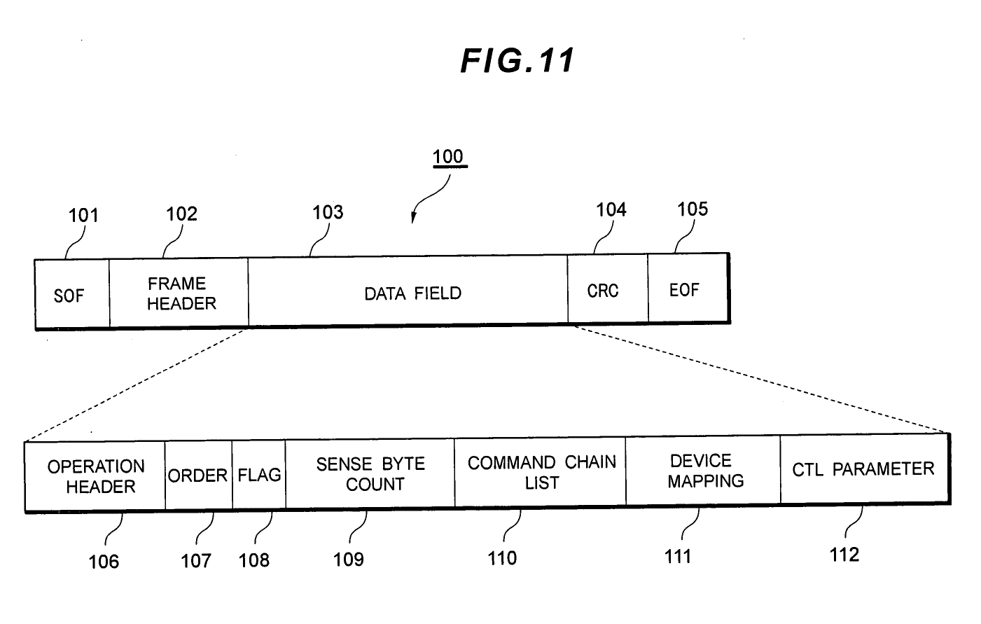

FIG. 11 shows a frame structure for a consolidated command 100 of this embodiment. The consolidated command 100 is comprised of SOF (Start OF FRAME) 101, frame header 102, data field 103, CRC (Cyclic Redundancy Check) 104, and EOF (End OF Frame) 105. The data field 103 is comprised of an optional header 106, an order 107, a flag 108, a sense byte counter 109, a command chain list 110, device mapping 111, and CTL parameter 112.

Here, the order 107 is information indicating which command of “control command for routing/device checking”, “command for control of mode setting/reading”, “command for sensing of mode setting/reading”, “command for control/sensing of mode setting/reading”, or “command to alias”” the consolidated command is.

Flag 108 is information indicating whether or not a command chain is present, and whether or not the same command is issued at all of the logical paths belonging to the same path group.

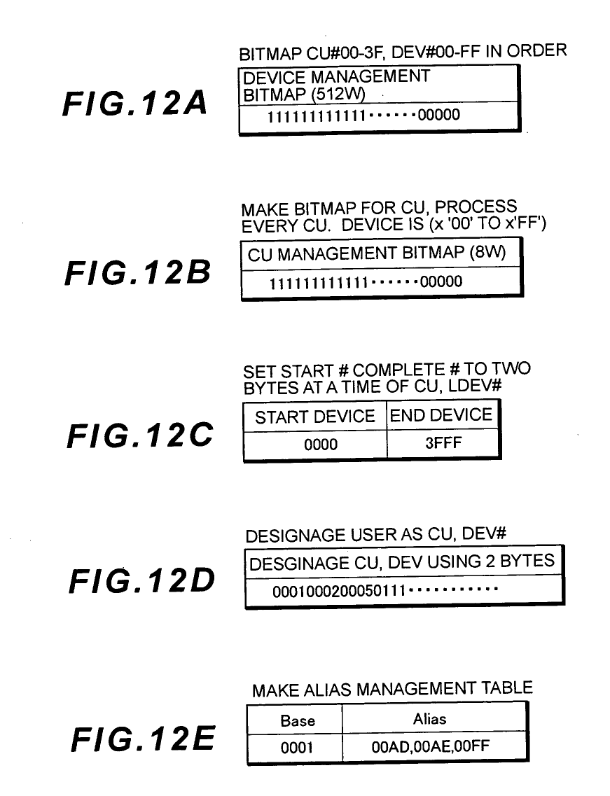

The device mapping 111 is information specifying the range of logical devices 41 constituting a target of consolidated command processing. Various methods can be considered as the method for designating a logical device 41. For example, as shown in FIG. 12A, information indicating whether or not respective logical devices 41 are designated may be represented using a bitmap format using “0 (not designated)” or “1 (designated)”. Alternatively, as shown in FIG. 12B, designation of the logical devices 41 may be carried out in units of control using the bitmap format. Further, as shown in FIG. 12C, stipulation is also possible using a combination of the control unit numbers and LDEV numbers of the first logical device 41 and the final logical device 41 of the designated range. Also, as shown in FIG. 12D, respective logical devices 41 may be designated using a combination of control unit numbers and LDEV numbers. Alternatively, as shown in FIG. 12E, stipulation is possible using an alias management table. Details of an alias management table are described in the following.

The CTL parameter 112 is, for example, a parameter (information for logical paths constituting the same path group, etc.) relating to a SET PI command.

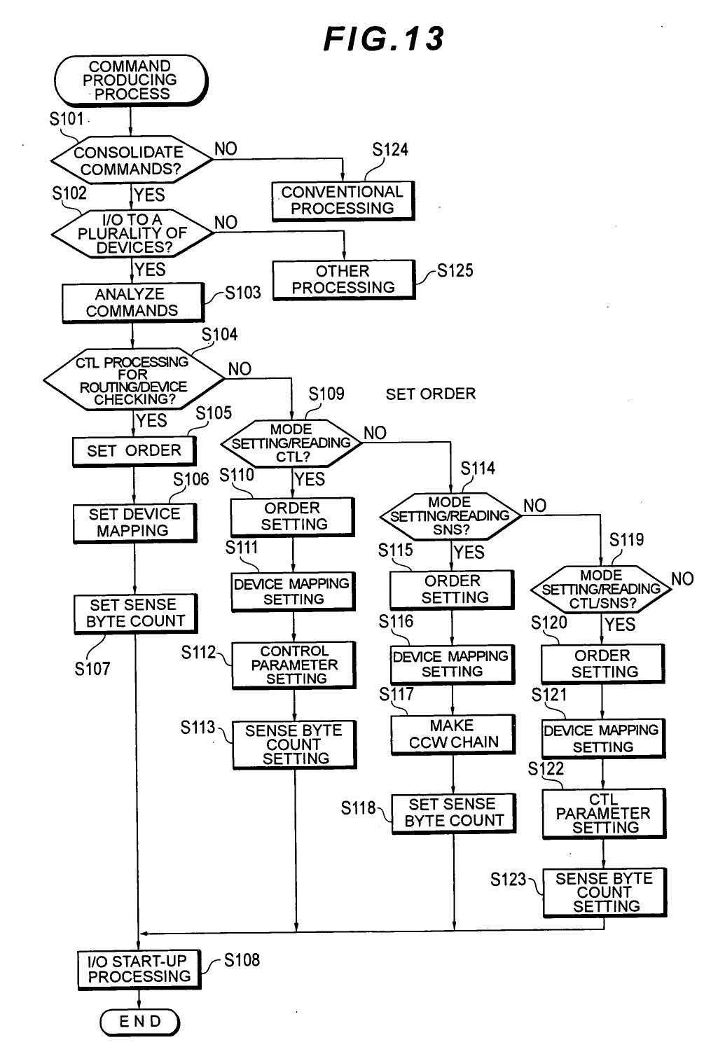

FIG. 13 is a flowchart showing processing for generating a consolidated command.

The arithmetic processing unit 24 determines whether or not to consolidate commands (S101). In the event that commands are not consolidated (S101: NO), processing of the related art is carried out (S124).

In the event that commands are consolidated (S101: YES), the arithmetic processing unit 24 checks whether or not the is an I/O processing request to the plurality of logical devices 41 (S102). In the event that I/O processing requests are not made to the plurality of logical devices 41 (S102: NO), the arithmetic processing unit 24 carries out other processing (S125). This other processing may be, for example, I/O processing requests to aliases (described later).

In the event that there are I/O processing requests to the plurality of logical devices 41 (S102: YES), the arithmetic processing unit 24 analyzes the type of command (S103).

In the event that a CTL process for routing/device checking is requested (S104: YES), the arithmetic processing unit 24 sets information indicating that the consolidated command is a command requesting a routing/device checking CTL process at the order 107 (S105).

Next, the arithmetic processing unit 24 designates the device mapping (S106), sets the sense byte count (S107), and applies I/O start-up processing to the channel section 21 (S108).

A total value for data acquired by process requests to all of the logical devices 41 by the consolidated command for sensing is then set at the sense byte count.

In the event that there is a request for a CTL process for mode setting/reading (S109: YES), the arithmetic processing unit 24 sets information indicating that the consolidated command is a command requesting a CTL process for mode setting/reading to the order 107 (S100).

Next, the arithmetic processing unit 24 designates the device mapping (S111), sets the CTL parameter 112 (S112), sets the sense byte count (S113), and applies I/O start-up processing to the channel section 21 (S108).

In the event that there is a request for an SNS process for mode setting/reading (S114: YES), the arithmetic processing unit 24 sets information indicating that the consolidated command is a command requesting a SNS process for mode setting/reading to the order 107 (S115).

Next, the arithmetic processing unit 24 designates the device mapping (S116), makes a CCW chain (S117), sets the sense byte count (S118), and applies I/O start-up processing to the channel section 21 (S108).

In the event that there is a request for a CTL/SNS process for mode setting/reading (S119: YES), the arithmetic processing unit 24 sets information indicating that the consolidated command is a command requesting a CTL/SNS process for mode setting/reading to the order 107 (S119).

Next, the arithmetic processing unit 24 designates the device mapping (S121), sets the CTL parameter (S122), sets the sense byte count (S123), and applies I/O start-up processing to the channel section 21 (S108).

The consolidated command generated by the aforementioned process is stored in the main storage 23 as channel program 80. The consolidated command is issued at the disc controller 30 by an I/O issuance process described later.

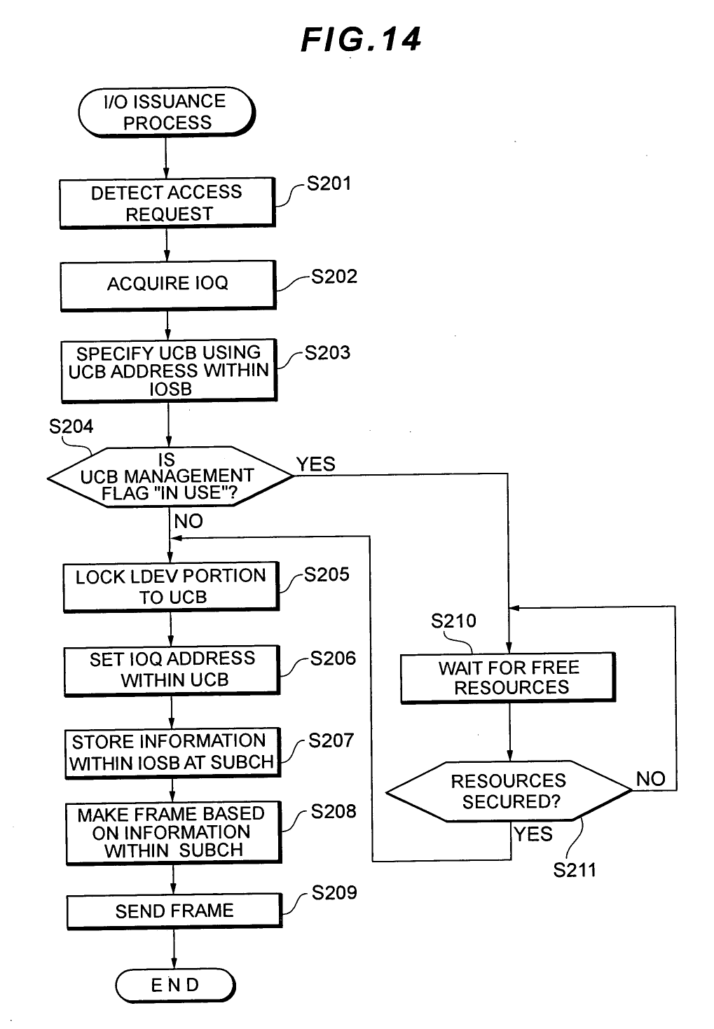

FIG. 14 is a flowchart showing I/O issuance processing.

When an access request is detected (S201), channel section 21 acquires IOQ 60 (S202), and specifies UCB 50 corresponding to the logical devices 41 constituting targets of I/O processing based on UCB address 72 registered in IOSB 70 (S203).

Next, the channel section 21 checks whether or not the management flag 56 of the specified UCB 50 indicates “in use” (S204). In the event that the management flag 56 indicates “in use” (S204: YES), the channel section 21 waits for resources to become available (i.e. waits for USB 50 to become free) (S210). If UCB 50 can be secured (S211: YES), the plurality of UCB's 50 corresponding to the plurality of logical devices 41 constituting the target of I/O processing are locked (S205). This is because, as only one command can be issued at the same logical device 41, it is necessary to lock the plurality of UCB's 50 within the designated range in order to designate a plurality of logical devices 41 with one consolidated command. The number of locked UCB's 50 and the number of logical devices 41 constituting the target of I/O processing are the same.

On the other hand, if the management flag 56 does not indicate “in use” (S204: NO), channel section 21 locks a plurality of UCB's 50 corresponding to the plurality of logical devices 41 constituting the target of I/O processing (S205).

The channel section 21 then sets the IOQ address 54 within the UCB's 50 (S206), and stores the information (channel program address 71, and UCB address 72) within the IOSB 70 at sub-channel 210 (S207).

Next, the channel section 21 makes a command frame based on the information stored in the sub-channel 210 (S208), and sends this command frame to the disc controller 30 (S209).

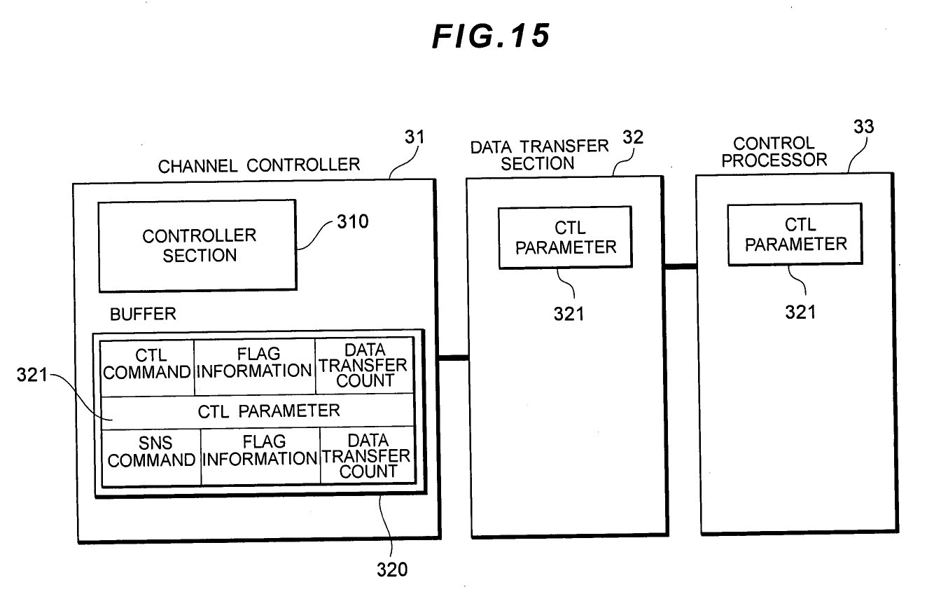

FIG. 15 is a view illustrating an outline of the consolidated command received from the central processing unit 20 processed by the disc controller 30. The channel controller 31 is comprised of a control section 310 and buffer 320. In the same drawing, a situation is shown where a consolidated command is stored in the buffer 320. As with within the CPU, a command code, flag information, a data transfer count, and parameters are stored in the buffer 320. The control section 310 determines the type of consolidated command based on the information of the order 107. The control section 310 extracts a parameter 321 from the consolidated command stored in the buffer 320 and sends this parameter 321 to the data transfer section 32. The data transfer section 32 sends the parameter 321 to the control processor 33. The control processor 33 then processes the consolidated command.

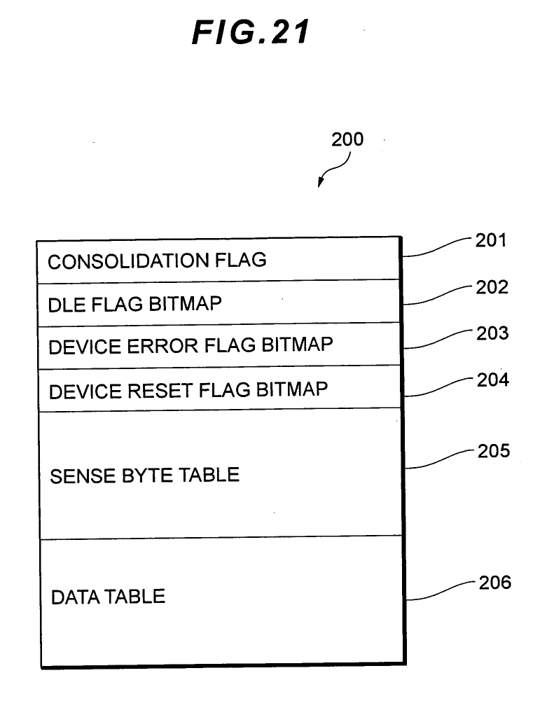

FIG. 21 shows a data format for response data 200. The response data 200 is data the disc controller 30 uses to respond to the central processing unit 20 as a response to the consolidated command. The response data 200 is comprised of a consolidation flag 201, a DLE flag bitmap 202, a device error flag bitmap 203, a device reset flag bitmap 204, a sense byte table 205, and a data table 206.

The consolidation flag 201 is information indicating whether the response data 200 is a response to a CTL command for routing/device checking, a response to a CTL command for mode setting/reading, a response to an SNS command for mode setting/reading, or a response to a CTL/SNS command for mode setting/reading.

The DLE flag bitmap 202 is bitmap information indicating whether or not the respective logical devices 41 are mounted.

The device error flag bitmap 203 is bitmap information indicating whether or not errors have occurred at the respective logical devices 41.

The device reset flag bitmap 204 is bitmap information indicating whether or not the respective logical devices 41 are reset.

The sense byte table 205 stores the cause of an error in the event that an error occurs at the logical device 41.

The data table 206 stores information acquired from the respective logical devices 41 using sense commands.

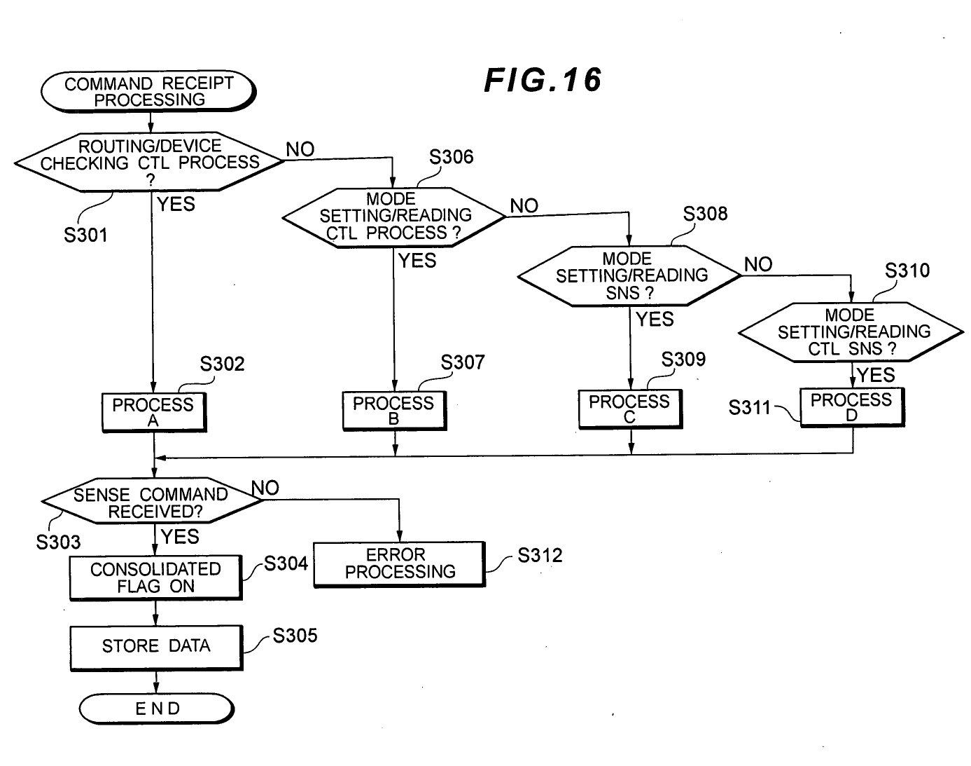

FIG. 16 is a flowchart describing command receipt processing occurring at a disc controller 30.

When a consolidated command is received, the channel controller 31 refers to the order 107, and checks whether or not the consolidated command is a CTL command for routing/device checking (S301), a CTL command for mode setting/reading (S306), an SNS command for mode setting/reading (S308), or a CTL/SNS command for mode setting/reading (S310).

In the event that the consolidated command is a CTL command for routing/device checking (S301: YES), the control processor 33 executes process A (S302).

In the event that the consolidation command is a CTL command for mode setting and reading (S306: YES), the control processor 33 executes process B (S307).

In the event that the consolidation command is an SNS command for mode setting and reading (S308: YES), the control processor 33 executes process C (S309).

In the event that the consolidation command is a CTL/SNS command for mode setting and reading (S310: YES), the control processor 33 executes process D (S311).

The details of process A to process D are described in the following.

When a sense command chained to the consolidated command is received (S303: YES), the control processor 33 sets the consolidation flag 201 within the response data 200 to on (S304), and data taken as processing results for the consolidated command is stored in each bitmap or each table within the response data 200 (S305).

In the event that a sense command chained to the consolidated command is not received (S303: NO), the control processor 33 carries out error processing (S312).

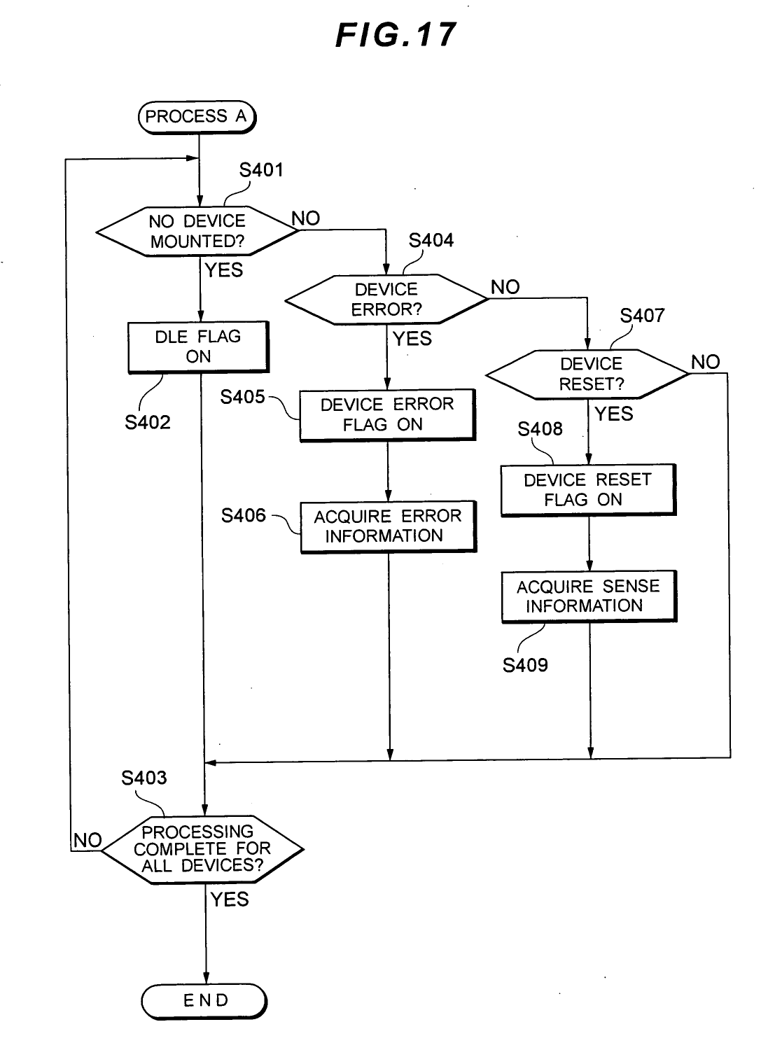

FIG. 17 is a flowchart showing a process A.

The control processor 33 checks whether or not logical devices 41 are mounted (S401). If a logical device 41 is not mounted (S401: YES), the control processor 33 sets the DLE flag to on (S402).

In the event that a logical device 41 is mounted (S401: NO), the control processor 33 checks whether or not a device error has occurred at the logical device 41 (S404). In the event that a device error has occurred at a logical device 41 (S404: YES), the control processor 33 sets a device error flag to on (S405), and stores error information in the sense byte table 205 of the response data 200 (S406).

In the event that a device error does not occur (S404: NO), the control processor 33 checks whether or not the logical device has been reset (S407). In the event that the logical device 41 is reset (S407: YES), the control processor 33 sets the device reset flag to on (S408), and stores the sense information in the sense byte table 205 of the response data 200 (S409).

If the logical device 41 is not reset (S407: NO), the logical device 41 is normal, and the control processor 33 carries out the processing of S403.

The control processor 33 then checks whether or not the above processing is complete for all of the logical devices 41 (S403). In the event that processing is not complete for some of the logical devices 41 (S403: NO), the control processor 33 returns to the processing of S401.

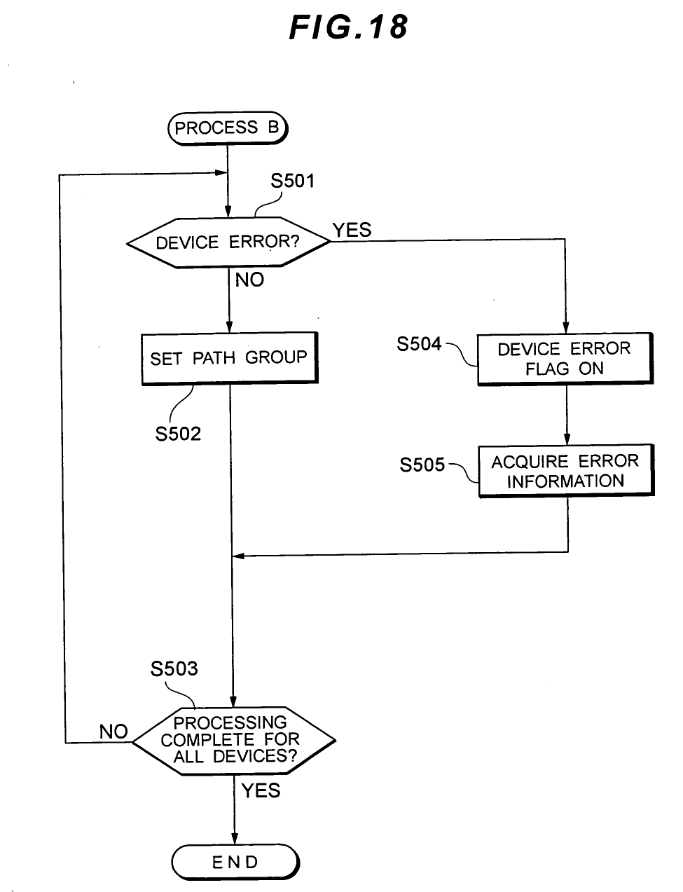

FIG. 18 is a flowchart showing a process B.

The control processor 33 checks whether or not a device error has occurred at a logical device 41 (S501). If a device error has not occurred at a logical device 41 (S501: NO), the control processor 33 sets a path group (S502).

In the event that a device error has occurred at a logical device 41 (S501: YES), the control processor 33 sets the device error flag to on (S504), and stores error information in the sense byte table 205 of the response data 200 (S505).

The control processor 33 then checks whether or not the above processing is complete for all of the logical devices 41 (S503). In the event that processing is not complete for some of the logical devices 41 (S503: NO), the control processor 33 returns to the processing of S501.

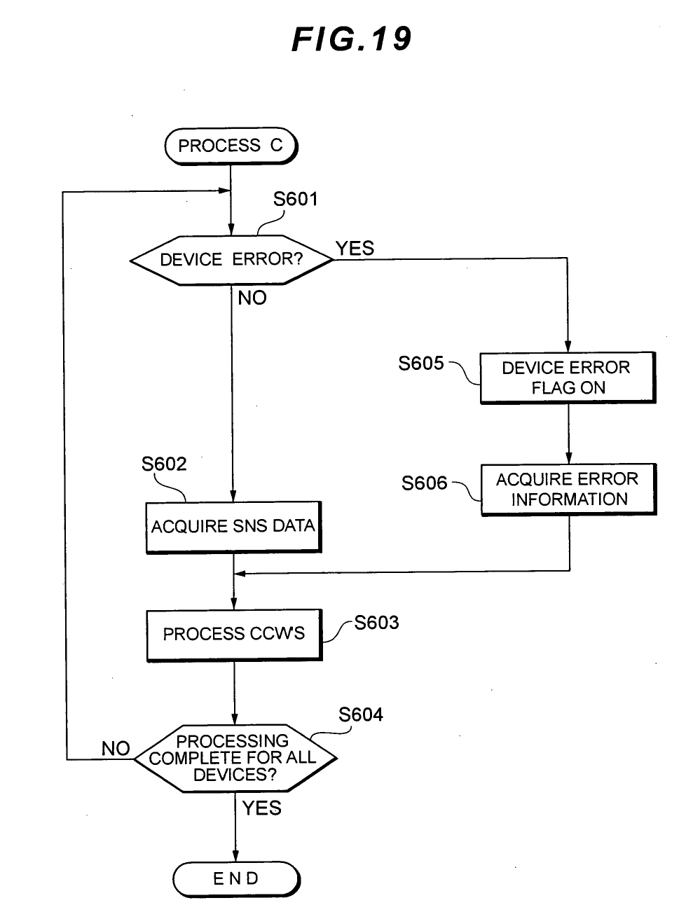

FIG. 19 is a flowchart showing a process C.

The control processor 33 checks whether or not a device error has occurred at a logical device 41 (S601). If a device error does not occur at the logical device 41 (S601: NO), the control processor 33 stores the sense data in the data table 206 of the response data 200 (S602), and carries out CCW processing on CCW's described on the command chain list (S603).

In the event that a device error has occurred at a logical device 41 (S601: YES), the control processor 33 sets the device error flag to on (S605), and stores error information in the sense byte table 205 of the response data 200 (S606).

The control processor 33 then checks whether or not the above processing is complete for all of the logical devices 41 (S604). In the event that processing is not complete for some of the logical devices 41 (S604: NO), the control processor 33 returns to the processing of S601.

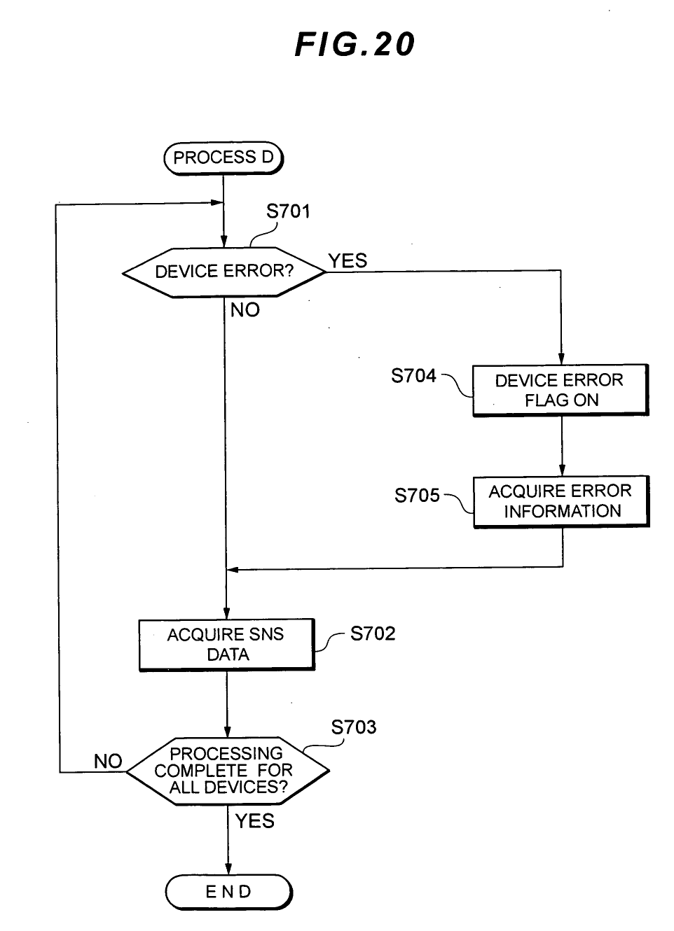

FIG. 20 is a flowchart showing a process D.

The control processor 33 checks whether or not a device error has occurred at a logical device 41 (S701). If a device error has not occurred at a logical device 41 (S701: NO), the control processor 33 stores the sense data in the data table 206 of the response data 200 (S702).

In the event that a device error has occurred at a logical device 41 (S701: YES), the control processor 33 sets the device error flag to on (S704), and stores error information in the sense byte table 205 of the response data 200 (S705).

The control processor 33 then checks whether or not the above processing is complete for all of the logical devices 41 (S703). In the event that processing is not complete for some of the logical devices 41 (S703: NO), the control processor 33 returns to the processing of S701.

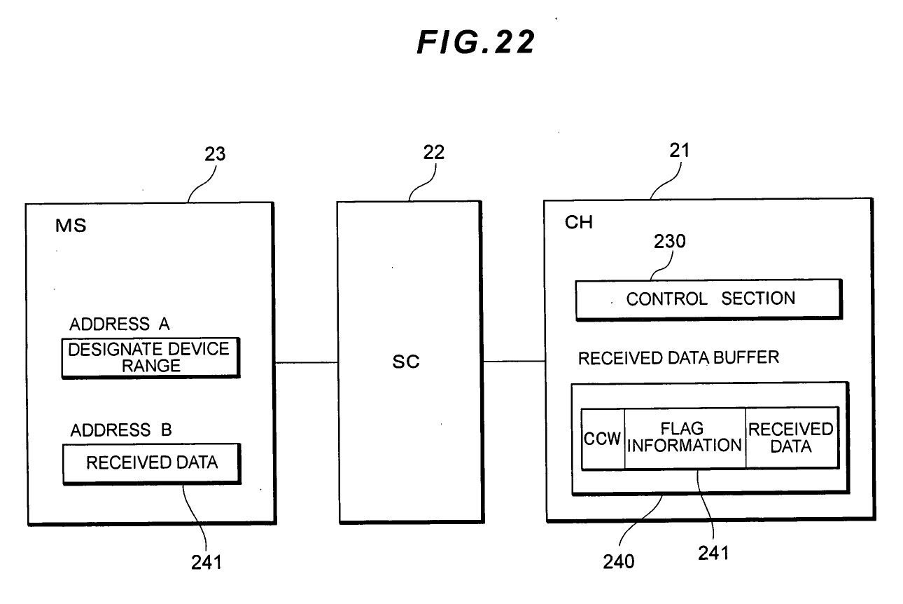

FIG. 22 is a view illustrating an outline of response data 200 received from the disc controller 30 processed by the central processing unit 20. The channel section 21 is comprised of a control section 230 and a received data buffer 240. In the same drawing, a situation is shown where response data is stored in the received data buffer 240. The control section 230 takes in received data 241 from the received data buffer 240 and stores this in address B of the main storage 23. The control section 230 determines the type of response data based on the information of the consolidation flag 201. The arithmetic processing unit 24 sets configuration information for logical devices 41 etc. based on the response data.

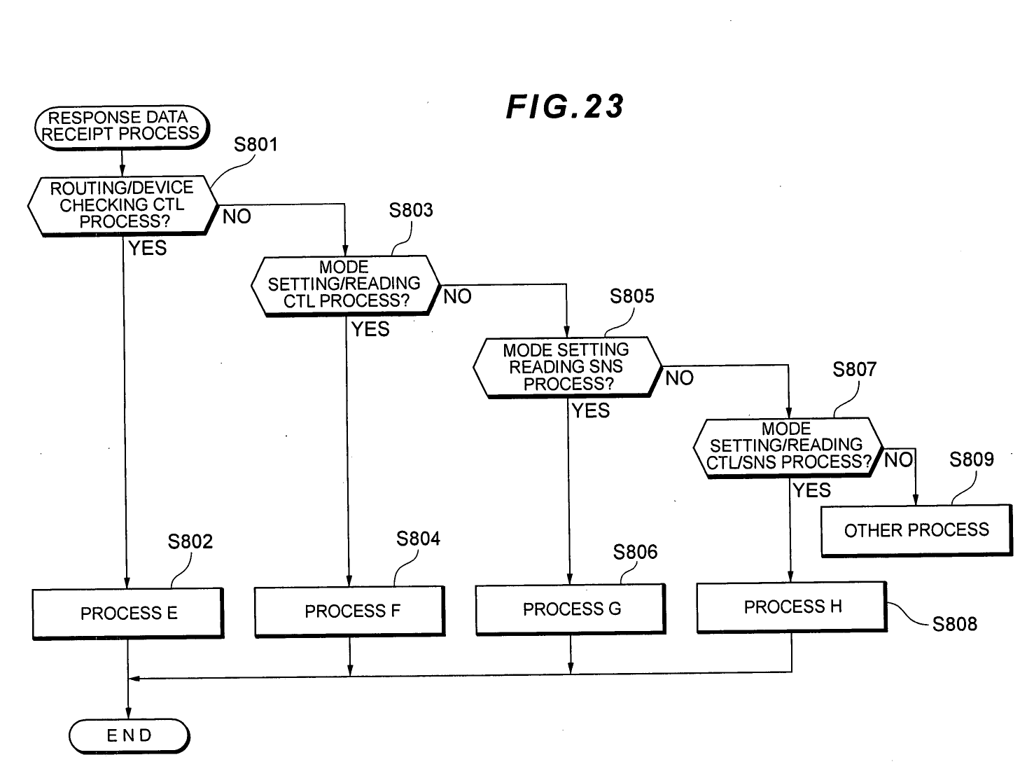

FIG. 23 is a flowchart describing response data receipt processing occurring at the central processing unit 20.

When the response data 200 is received, the channel section 21 refers to the consolidation flag 201 and checks whether the response data 200 is a response to a CTL command for routing/device checking (S801), a response to a CTL command for mode setting/reading (S803), a response to an SNS command for mode setting/reading (S805), or a response to a CTL/SNS command for mode setting/reading (S807).

In the event that the response data 200 is a response to a CTL command for routing/device checking (S801: YES), the arithmetic processing unit 24 executes process E (S802).

In the event that the response data 200 is a response to a CTL command for mode setting/reading (S803: YES), the arithmetic processing unit 24 executes process F (S804).

In the event that the response data 200 is a response to a SNS command for mode setting/reading (S805: YES), the arithmetic processing unit 24 executes process G (S806).

In the event that the response data 200 is a response to a CTL/SNS command for mode setting/reading (S807: YES), the arithmetic processing unit 24 executes process H (S808).

In the event that the response data 200 is not a response to any command (S807: NO), the arithmetic processing unit 24 carries out other processing (S809). For example, processing of response results to an I/O request to an alias (described later) etc. may be given as other processing.

The details of process E to process H are described in the following.

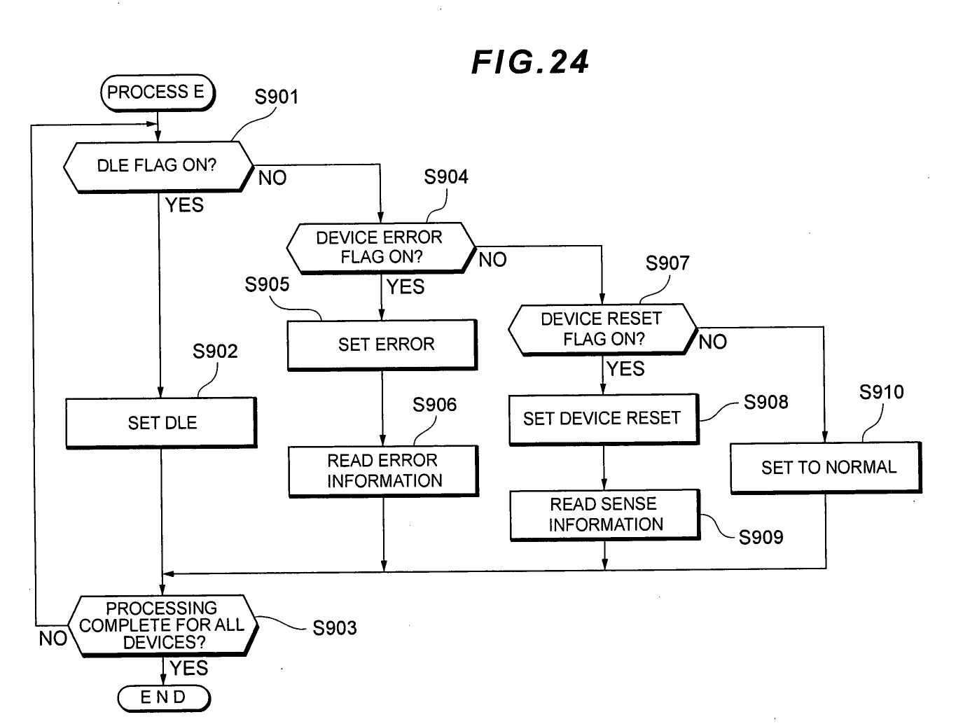

FIG. 24 is a flowchart showing a process E.

The arithmetic processing unit 24 checks whether or not a DLE flag is set to on (S901). In the event that the DLE flag is set to on (S901: YES), the arithmetic processing unit 24 performs setting (DLE setting) to the effect that a logical device 41 is not mounted (S902).

In the event that the DLE flag is off (S901: NO), the arithmetic processing unit 24 checks whether or not the device error flag is on (S904). In the event that the device error flag is set to on (S904: YES), the arithmetic processing unit 24 carries out error setting for a logical device 41 (S905), and acquires error information from the sense byte table 205 of the response data 200 (S906).

In the event that the device error flag is off (S904: NO), the arithmetic processing unit 24 checks whether or not the device reset flag is on (S907). In the event that the device reset flag is on (S907: YES), the arithmetic processing unit 24 resets of the logical device 41 (S908), and acquires sense information from the sense byte table 205 of the response data 200 (S909).

In the event that the device reset flag is off (S907: NO), the arithmetic processing unit 24 sets the logical device to normal (S910).

The arithmetic processing unit 24 then checks whether or not the aforementioned process is complete for all of the logical devices 41 (S903). In the event that processing is not complete for some of the logical devices 41 (S903: NO), the arithmetic processing unit 24 returns to the processing of S901.

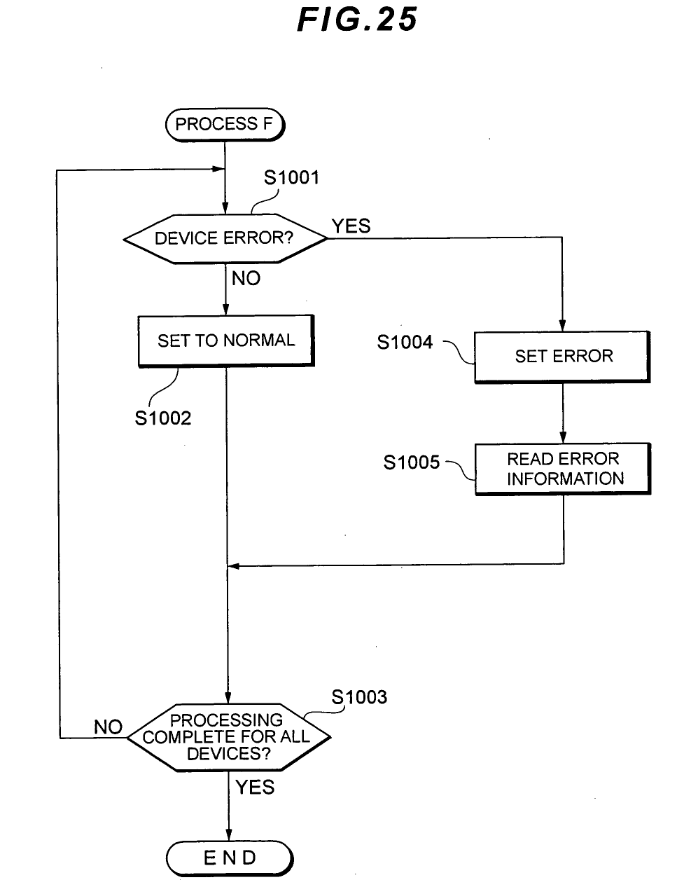

FIG. 25 is a flowchart showing a process F.

The arithmetic processing unit 24 checks whether or not a device error has occurred at a logical device 41 (S1001). If a device error has not occurred at a logical device 41 (S1001: NO), the arithmetic processing unit 24 carries out normal setting (S1002).

In the event that a device error occurs at the logical device 41 (1001: YES), the arithmetic processing unit 24 sets that an error has occurred at the logical device 41 (S1004), and error information is acquired from the sense byte table 205 of the response data 200 (S1005).

The arithmetic processing unit 24 then checks whether or not the aforementioned process is complete for all of the logical devices 41 (S1003). In the event that processing is not complete for some of the logical devices 41 (S1003: NO), the arithmetic processing unit 24 returns to the processing of S1001.

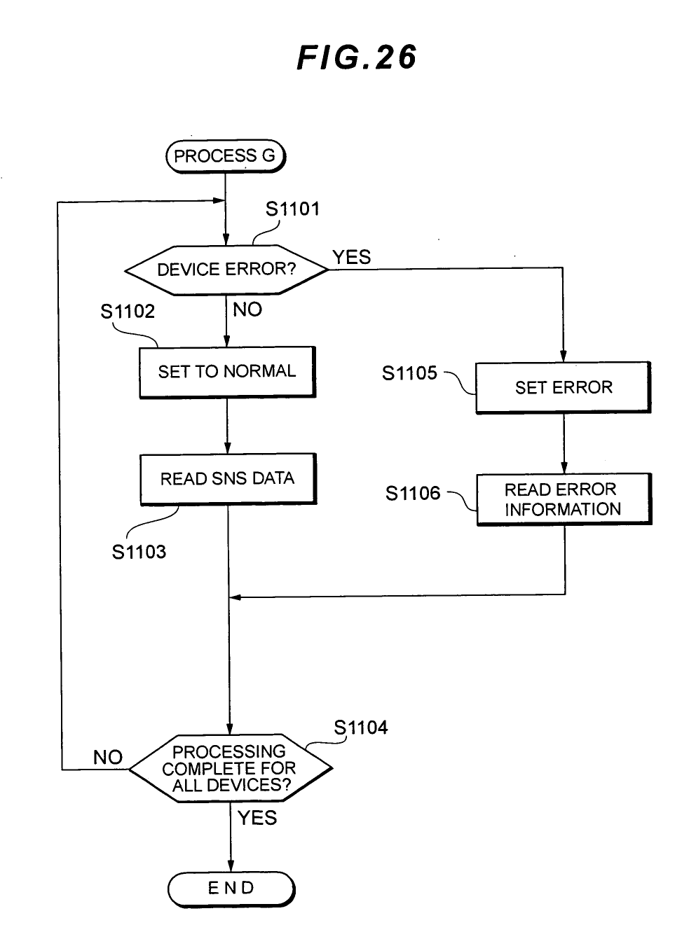

FIG. 26 is a flowchart showing a process G.

The arithmetic processing unit 24 checks whether or not a device error has occurred at a logical device 41 (S1101). If a device error has not occurred at a logical device 41 (S1101: NO), the arithmetic processing unit 24 sets the logical device to normal (S1102), and acquires sense data from the data table 206 of the response data 200 (S1103).

In the event that a device error has occurred at the logical device 41 (1101: YES), the arithmetic processing unit 24 sets that an error has occurred at the logical device 41 (S1105), and error information is acquired from the sense byte table 205 of the response data 200 (S1106).

The arithmetic processing unit 24 then checks whether or not the aforementioned process is complete for all of the logical devices 41 (S1104). In the event that processing is not complete for some of the logical devices 41 (S1104: NO), the arithmetic processing unit 24 returns to the processing of S1101.

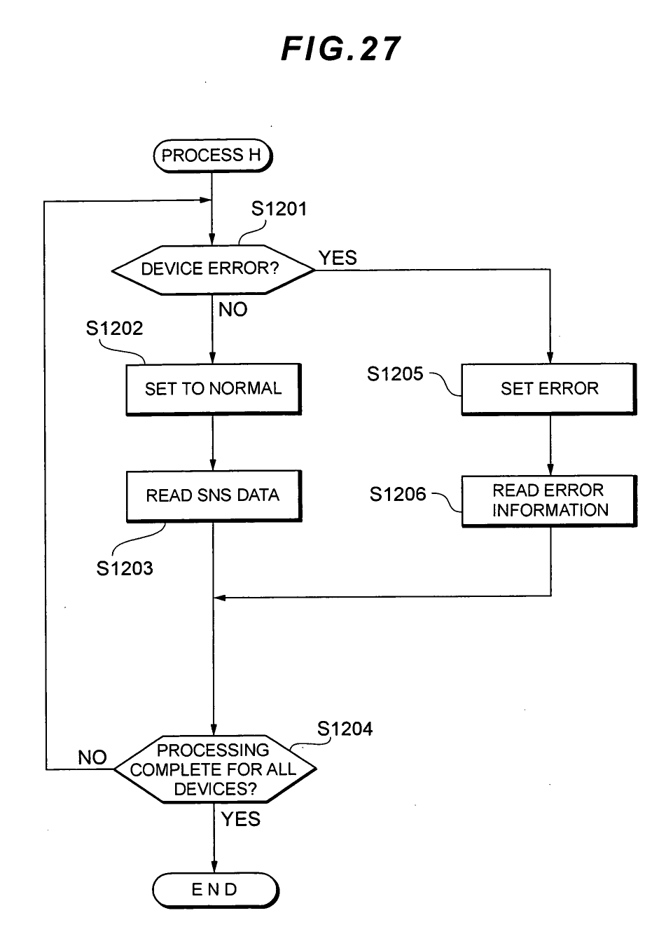

FIG. 27 is a flowchart showing a process H.

The arithmetic processing unit 24 checks whether or not a device error has occurred at a logical device 41 (S1201). If a device error has not occurred at a logical device 41 (S1201: NO), the arithmetic processing unit 24 sets the logical device to normal (S1202), and acquires sense data from the data table 206 of the response data 200 (S1203).

In the event that a device error occurs at the logical device 41 (1201: YES), the arithmetic processing unit 24 sets that an error has occurred at the logical device 41 (S1205), and error information is acquired from the sense byte table 205 of the response data 200 (S1206).

The arithmetic processing unit 24 then checks whether or not the aforementioned process is complete for all of the logical devices 41 (S1204). In the event that processing is not complete for some of the logical devices 41 (S1204: NO), the arithmetic processing unit 24 returns to the processing of S1201.

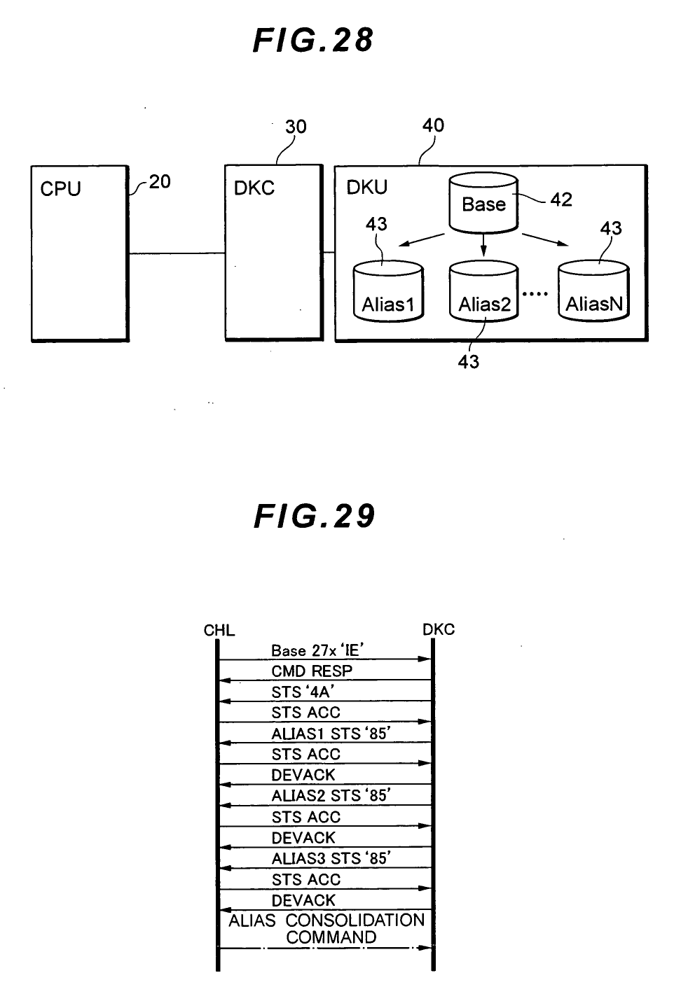

FIG. 28 shows an outline of a configuration for a data processing system. The disc unit 40 is such that a plurality of alias devices 43 are allocated to a single base device 42. A UCB (Unit Control Block) managing I/O requests to the base device 42 and UCB's managing I/O requests to respective alias devices 43 are different. The central processing unit 20 is capable of making requests for a plurality of I/O processes to the base device 42 using UCB's for the alias devices 43. In this case also, if the I/O request to the respective alias devices 43 is the same, it is possible to gather commands issued to the respective alias devices 43 into a single command (hereinafter referred to as a “alias consolidation command”) by using the consolidated command described above.

FIG. 29 is a view showing a sequence for issuing an alias consolidation command. When a command code 22×‘IE’ order is issued by the central processing unit 20 to the base device 42, STS‘85’ is sent from all of the alias devices 43 defined at the disc controller 30 to the central processing unit 20 as a response to this. The central processing unit 20 then acquires information relating to the alias devices 43 allocated to the base device 42 by receiving these responses. The central processing unit 20 is capable of making the alias management table shown in FIG. 12E. The alias management table correlates the LDEV number of the base drive and the LDEV numbers of the one or more alias devices allocated to this base device. The central processing unit 20 is capable of issuing an alias consolidation command to the disc controller 30 by setting the order 107 of the consolidated command to alias use and designating the alias management table as the device mapping 111. The disc controller 30 carries out command receipt processing in the same order as described above.

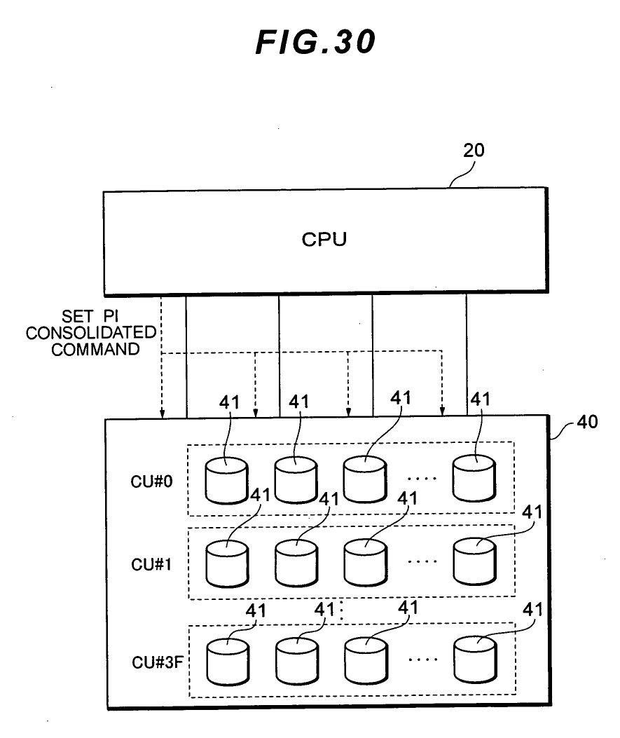

FIG. 30 shows an outline of a configuration for a data processing system. In this embodiment, when a SET PI command (hereinafter referred to as “SET PI consolidated command”) is issued by the central processing unit 20 to one of the logical paths belonging to a certain path group, the disc controller 30 is capable of issuing SET PI commands from all of the other logical paths belonging to the same path group. Namely, commands can be consolidated in path group units. The central processing unit 20 is capable of issuing a SET PI consolidated command at the disc controller 30 by setting the information of the flag 108 for the consolidated command to “SET PI consolidated command” use, and setting information for logical paths belonging to the same path group to the CTL parameter 112.

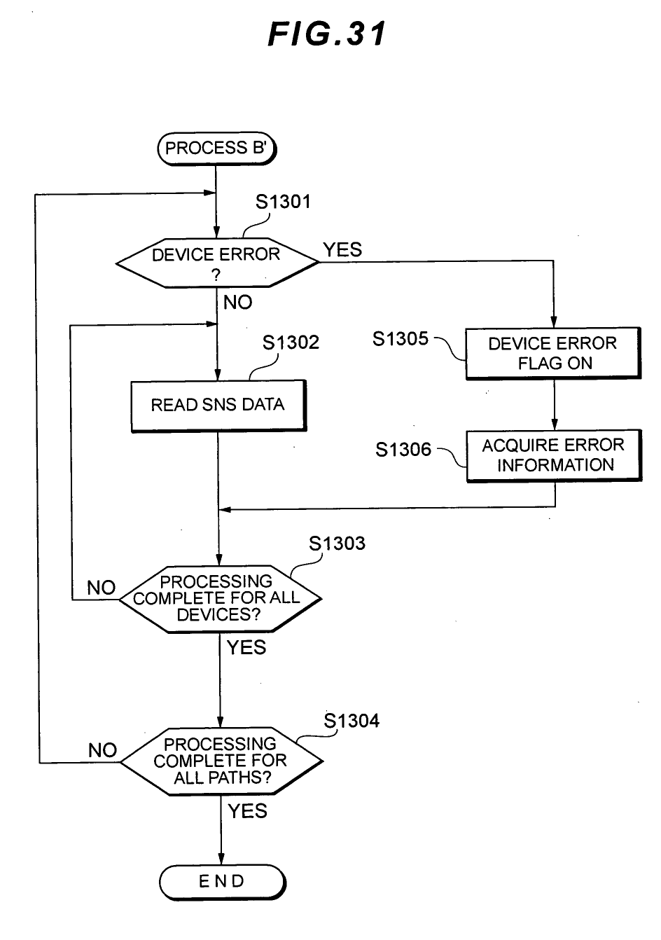

FIG. 31 is a flowchart showing a process B′ executed by a disc controller receiving a SET PI consolidated command.

The control processor 33 checks whether or not a device error has occurred at a logical device 41 (S1301). If a device error has not occurred at a logical device 41 (S1301: NO), the control processor 33 stores the sense data in the data table 206 of the response data 200 (S1302).

In the event that a device error has occurred at a logical device 41 (S1301: YES), the control processor 33 sets the device error flag to on (S1304), and stores error information in the sense byte table 205 of the response data 200 (S1305).

The control processor 33 then checks whether or not the above processing is complete for all of the logical devices 41 (S1303). In the event that processing is not complete for some of the logical devices 41 (S1303: NO), the control processor 33 returns to the processing of S1302.

The control processor 33 then checks whether or not the above processing is complete for all of the logical paths (S1304). In the event that processing is not complete for some of the logical paths (S1304: NO), the control processor 33 returns to the processing of S1301.

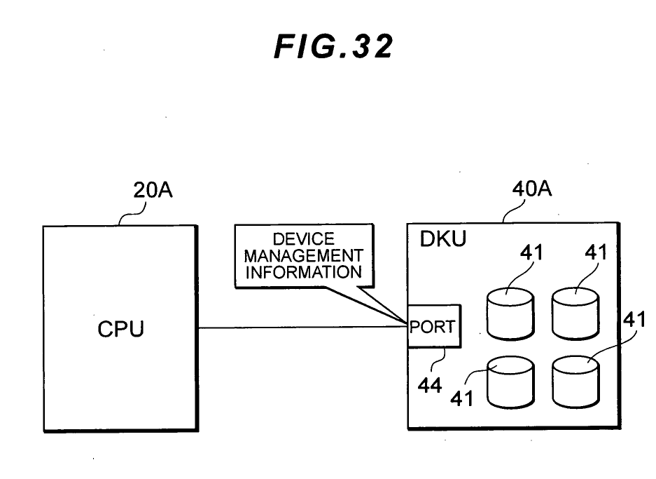

FIG. 32 shows an outline of a configuration for an open data processing system. The open data processing system is equipped with an open system central processing unit 20A and a disc unit 40A. A port 44 mounted on the disc unit 40A holds management information (for example, LUN information) for the logical devices 41. With the IPL process and CHP ON process occurring in the open system, an Inquiry command, TestUnitReady command, StartStopUnit command, ModeSenseKI command, and Read command etc. are issued from the central processing unit 20A to the disc unit 40A.

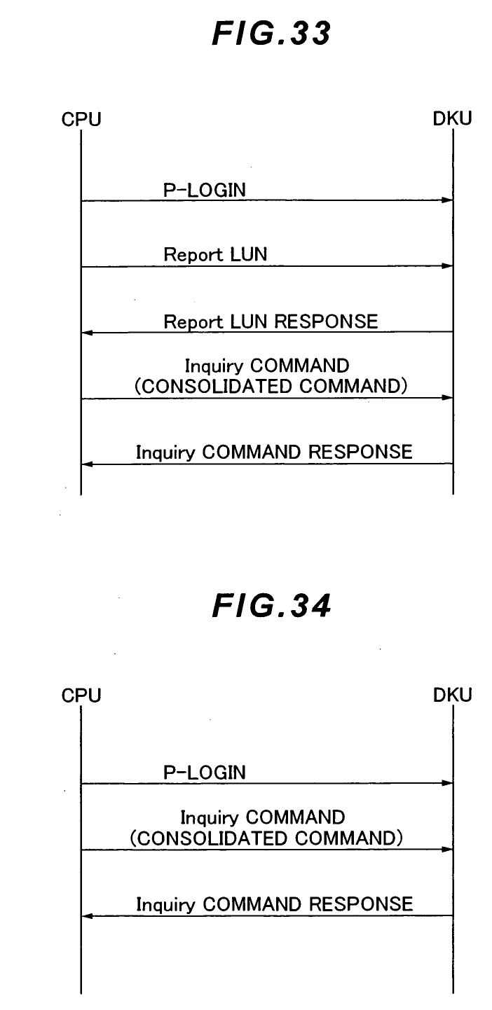

FIG. 33 is a sequence view showing a consolidated command issuance procedure for the case where the central processing unit 20A constitutes and open system. In the same drawing, P-LOGIN and ReportLUN are issued by the central processing unit 20A to the disc unit 40A. In doing so, LU (logical unit) information managed by the port 44 is provided by the disc unit 40A as a ReportLUN response. The central processing unit 20A then issues an Inquiry command (consolidated command) designating a plurality of LU numbers as the device range based on LU information acquired from the disc controller 30. In doing so, a reply is also made from the disc controller 40A in the form of information such as the designated respective LU vendor name, type, storage capacity, and emulation type as an Inquiry command (consolidated command) response.

FIG. 34 is a sequence view showing a consolidated command issuance procedure for the case where the central processing unit 20A constitutes an open system. In the same drawing, in addition to P-LOGIN being issued by the central processing unit 20A to the disc unit 40A, an Inquiry command (consolidated command) designating a plurality of LU numbers as the device range is issued. In doing so, a reply is also made from the disc controller 40A in the form of information such as the designated respective LU vendor name, type, storage capacity, and emulation type as an Inquiry command (consolidated command) response.

In the above description, an example is shown where a single type of command issued to a plurality of logical devices 41 is consolidated in control unit units or path group units. However, it is also possible for a plurality of types of commands issued consecutively at a plurality of logical devices 41 to be consolidated in control unit units or path group units. Specifically, in addition to specifying a plurality of logical devices 41 constituting processing targets of an I/O request, the number of UCB's is locked to be the same as the number of logical devices 41, a plurality of types of CCW command are chained, and commands are consolidated in units of control units or path group units. The disc controller 30 receiving the consolidated command where a plurality of CCW commands are consolidated in control unit units or in path group units then separates the CCW chain using the channel controller 31, and processes the plurality of different types of commands for each of the respective logical devices 41 in the designated range. The procedure for generating the response data 200 is the same as the procedure described above.

According to this embodiment, in the event that the central processing unit 20 carries out processing requests for a plurality of logical devices 41, by simply sending a consolidated command from the central processing unit 20 to the disc controller 30, the time required for an IPL process and CHP ON process etc. can be substantially shortened by the disc controller 30 carrying out command processing for all of the logical devices 41 within the processing range designated by the consolidated command.

What is claimed is:

1. A data processing system comprising:
a disc unit having a plurality of logical devices;
a central processing unit issuing a CTL command for routing/device checking, a CTL command for mode setting/reading, an SNS command for mode setting/reading, or a CTL/SNS command for mode setting/reading taking a plurality of logical devices as a processing range; and
a disc controller executing the commands for all of the logical devices designated as the processing range.

2. The data processing system according to claim 1, wherein, upon receiving a response to the command from the disc controller, the central processing unit checks whether the response is a response to a CTL command for routing/device checking, a response to a CTL command for mode setting/reading, a response to an SNS command for mode setting/reading, or a response to a CTL/SNS command for mode setting/reading, and carries out receipt processing for the response for all of the logical devices designated in the processing range.

3. The data processing system according to claim 1, wherein the command is issued by the central processing unit to the disc controller so as to execute an initial program load or channel path online.

4. The data processing system according to claim 1, wherein sense commands for collecting together information relating to all of the logical devices designated as the processing range for reading out from the disc controller are chained to the designated commands taking the plurality of logical devices as the processing range.

5. The data processing system according to claim 1, wherein the central processing unit comprises a unit control block for managing input and output requests to the logical devices, and for locking a plurality of unit control blocks correlating respectively to all of the logical devices designated as the processing range.

6. The data processing system according to claim 1, wherein the processing range is all logical devices belonging to the same control unit.

7. The data processing system according to claim 1, wherein information for logical paths belonging to the same path group is included in the command, and the disc controller executes the command for all of the logical paths belonging to the same path group.

8. The data processing system according to claim 1, wherein the command is a plurality of different types of commands chained together.

9. The data processing system according to claim 1, wherein the disc unit comprises a base device and a plurality of alias devices allocated to the base device, information indicating the relationship between the base device and the plurality of alias devices allocated to the base device is included as the processing range, and the disc controller processes a plurality of processing requests to the plurality of alias devices as processing requests to the base device.

10. A data processing system comprising:
a disc unit having a plurality of logical devices;
a central processing unit for a mainframe for issuing a CTL command for routing/device checking, a CTL command for mode setting/reading, an SNS command for mode setting/reading, or a CTL/SNS command for mode setting/reading with a plurality of logical devices designated as the processing range by executing by executing initial program load or channel path online; and
a disc controller executing the commands for all of the logical devices designated as the processing range.

11. The data processing system according to claim 10, wherein, upon receiving the command response from the disc controller, the central processing unit checks whether the response is a response to a CTL command for routing/device checking, a response to a CTL command for mode setting/reading, a response to an SNS command for mode setting/reading, or a response to a CTL/SNS command for mode setting/reading, and carries out receipt processing for the response for all of the logical devices designated in the processing range.

12. A data processing method comprising the steps of:
issuing a CTL command for routing/device checking, a CTL command for mode setting/reading, an SNS command for mode setting/reading, or a CTL/SNS command for mode setting/reading taking a plurality of logical devices as a processing range; and
executing the commands for all of the logical devices designated as the processing range.

13. The data processing method according to claim 12, further comprising a step of, upon receiving the command response, checking whether the response is a response to a CTL command for routing/device checking, a response to a CTL command for mode setting/reading, a response to an SNS command for mode setting/reading, or a response to a CTL/SNS command for mode setting/reading, and carries out receipt processing for the response for all of the logical devices designated in the processing range.

14. The data processing method according to claim 12, wherein the command is issued by the central processing unit to the disc controller so as to execute an initial program load or channel path online.

15. The data processing method according to claim 12, wherein sense commands for collecting together information relating to all of the logical devices designated as the processing range for reading out from the disc controller are chained to the designated commands taking the plurality of logical devices as the processing range.

16. The data processing method according to claim 12, further comprising a step of locking a plurality of unit control blocks correlating respectively to all of the logical devices designated in the processing range.

17. The data processing method according to claim 12, wherein the processing range is all logical devices belonging to the same control unit.

18. The data processing method according to claim 12, wherein information for logical paths belonging to the same path group is included in the command, and the command execution step executes the command for all of the logical paths belonging to the same path group.

19. The data processing method according to claim 12, wherein the command is a plurality of different types of commands chained together.

20. The data processing method according to claim 12, wherein information indicating the relationship between a base device and a plurality of alias devices allocated to the base device is included as the processing range, and the command execution step processes a plurality of processing requests to the plurality of alias devices as processing requests to the base device.
